(19) United States
(12) Patent Application Publication
(10) Pub. No.: US 2024/0060697 A1
(43) Pub. Date: Feb. 22, 2024

(54) ICE PACK APPARATUS

(71) Applicant: Allan Wendling, Fenton, MI (US)

(72) Inventor: Allan Wendling, Fenton, MI (US)

(21) Appl. No.: 18/450,490

(22) Filed: Aug. 16, 2023

Related U.S. Application Data
(60) Provisional application No. 63/398,572, filed on Aug. 17, 2022.

(51) Int. Cl. F25D 3/08

(52) U.S. Cl. CPC F25D 3/08; F25D 2303/0822; F25D 2303/085

(57) ABSTRACT

The present disclosure relates to a composition including a sodium acrylate polymer, antifreeze proteins, sodium chloride, and magnesium glycinate. The present disclosure further relates to an ice pack apparatus including a body with one or more walls that define a cavity that holds a composition including a sodium acrylate polymer, antifreeze proteins, sodium chloride, and magnesium glycinate

### TECHNICAL FIELD

The present disclosure relates to cooling apparatuses and associated compositions and, more specifically, to ice pack apparatuses and associated compositions.

### BACKGROUND

Various apparatuses may be used for cooling objects (e.g., to contact an object in order to lower and/or maintain a temperature of the object). In addition, various compositions may be provided in such apparatuses in order to achieve such a cooling effect. However, such apparatuses and/or associated compositions do not achieve sufficient cooling in some instances. As such, new apparatuses and/or associated compositions may be desirable.

### SUMMARY

According to one or more embodiments, a composition includes a sodium acrylate polymer, antifreeze proteins, sodium chloride. and magnesium glycinate. According to one or more embodiments, an ice pack apparatus includes a body having one or more walls defining a cavity that holds a composition including a sodium acrylate polymer, antifreeze proteins, sodium chloride and magnesium glycinate.

### BRIEF DESCRIPTION OF THE DRAWINGS

The following detailed description of specific embodiments of the present disclosure can be best understood when read in conjunction with the following drawings, where like structure is indicated with like reference numerals and wherein:

FIG. 1 depicts a front view of an illustrative ice pack apparatus, according to one or more embodiments shown and described herein;

FIG. 2 depicts a back view of an illustrative ice pack apparatus, according to one or more embodiments shown and described herein;

FIG. 3 depicts a front view of another illustrative ice pack apparatus having a transparent section, according to one or more embodiments shown and described herein;

FIG. 4 depicts a front view of another illustrative ice pack apparatus divided into a plurality of sections, according to one or more embodiments shown and described herein;

FIG. 5 depicts a front view of another illustrative ice pack apparatus having a body that forms a cylindrical structure defining a hollow center portion, according to one or more embodiments shown and described herein; and

FIG. 6 depicts a front view of another illustrative ice pack apparatus having an internal capsule disposed within the body of the ice pack apparatus, according to one or more embodiments shown and described herein.

These and other embodiments are described in more detail in the detailed description. It is to be understood that both the foregoing general description and the following detailed description describe present embodiments of the technology, and are intended to provide an overview or framework for understanding the nature and character of the technology as it is claimed. The accompanying drawings are included to provide a further understanding of the technology and are incorporated into and constitute a part of this specification. The drawings illustrate various embodiments and, together with the description, serve to explain the principles and operations of the technology. Additionally, the drawings and descriptions are meant to be merely illustrative, and are not intended to limit the scope of the claims in any manner.

### DETAILED DESCRIPTION

The present disclosure is directed to ice pack apparatuses and/or compositions. The compositions may include a sodium acrylate polymer, antifreeze proteins, sodium chloride, and magnesium glycinate. The presence of the sodium acrylate polymer, antifreeze proteins, sodium chloride, and magnesium glycinate in the compositions may result in the ice pack apparatuses achieving a relatively lower cooling temperature when compared to conventional ice pack apparatuses and compositions. In addition, the presence of the sodium acrylate polymer, antifreeze proteins, sodium chloride, and magnesium glycinate in the compositions may result in the ice pack apparatuses remaining at this relatively lower cooling temperature for a longer time period when compared to conventional ice pack apparatuses and compositions. Further, the sodium acrylate polymer, antifreeze proteins, sodium chloride, and magnesium glycinate may result in the compositions in the ice pack apparatuses being more acceptable for use than those ice pack apparatuses that contain ammonium nitrate. The ice pack apparatuses may include a body having one or more walls, where the one or more walls define a cavity and wherein the cavity holds a composition therein (including, for example, the various compositions described herein).

While the present disclosure describes ice pack compositions as illustrative examples of the particular compositions shown and described herein, the present disclosure is not solely limited to ice pack compositions. That is, in some embodiments, the compositions described herein may be used for other purposes such as, for example, in medical equipment, medications, compression pads, cooling gels, plastic bags, food and beverage containers/apparatuses, shipping containers/apparatuses, etc. As such, it should be appreciated that the terms “composition” and “ice pack composition” may be used interchangeably herein, and the inclusion of the term “ice pack” is not meant to be limiting.

In one or more embodiments, the composition may include a sodium acrylate polymer. The sodium acrylate polymer may have long-chain copolymers consisting of alternating acrylic acid and sodium acrylate components, as shown below:

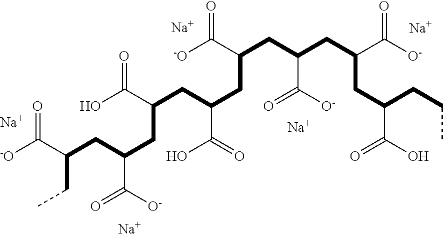

The dotted lines represent where the long-chain copolymers may include a plurality of additional alternating acrylic acid and sodium acrylate components. The sodium acrylate polymer may include a plurality of these long-chain copolymers, where one or more long-chain copolymers may cross-link with one or more other long-chain copolymers.

In one or more embodiments, the composition may include from about 50 wt. % to about 99 wt. % of the sodium acrylate polymer, based on the total weight of the composition. For example, in some embodiments, the composition may include from about 55 wt. % to about 99 wt. %, from about 60 wt. % to about 99 wt. %, from about 65 wt. % to about 99 wt. %, from about 70 wt. % to about 99 wt. %, from about 75 wt. % to about 99 wt. %, from about 80 wt. % to about 99 wt. %, from about 85 wt. % to about 99 wt. %, from about 90 wt. % to about 99 wt. %, from about 50 wt. % to about 95 wt. %, from about 50 wt. % to about 90 wt. %, from about 50 wt. % to about 85 wt. %, from about 50 wt. % to about 80 wt. %, from about 50 wt. % to about 75 wt. %, from about 50 wt. % to about 70 wt. %, from about 50 wt. % to about 65 wt. %, from about 50 wt. % to about 60 wt. %, from about 55 wt. % to about 95 wt. %, from about 65 wt. % to about 95 wt. %, or from about 75 wt. % to about 95 wt. % of the sodium acrylate polymer, based on the total weight of the composition.

In one or more embodiments, the composition may include one or more polymers in addition to the sodium acrylate polymer. In some embodiments, the composition may include the same long-chain copolymer structure with alternating acrylic acid and acrylate components having a different positively-charged ion, for example, potassium, lithium, ammonium, etc. In some embodiments, the composition may include one or more superabsorbent polymers with varying structures. The term “superabsorbent polymer” may generally be described as a water-absorbing, hydrophilic compound that may absorb and retain substantially large amounts of a liquid relative to its own mass. For example, the composition may further include one or more of a polyacrylamide copolymer, an ethylene maleic anhydride copolymer, cross-linked carboxymethylcellulose, polyvinyl alcohol copolymers, cross-linked polyethylene oxide, and starch grafted copolymers of polyacrylonitrile.

Without being bound by a theory, it is believed that when the sodium acrylate polymer is contacted with water, the carboxyl groups of the sodium acrylate polymer are forced apart and create space for the present water molecules. As the carboxyl groups are forced apart and the water molecules move into these open spaces and bond with surrounding atoms in at least a portion of the sodium acrylate polymer, the sodium acrylate polymer increases in size and may form a composition having the consistency of a gel (which is sometimes referred to as a hydrogel). In some embodiments, the sodium acrylate polymer may absorb at least 2 times, at least 5 times, at least 20 times, at least 50 times, at least 100 times, or even at least 300 times its weight when contacted with the water.

In one or more embodiments, the composition may include antifreeze proteins. In some embodiments, the composition may include one or more types of antifreeze proteins. The term “antifreeze protein,” sometimes referred to as an “ice structuring protein,” refers to a class of proteins and/or polypeptides produced by certain animals, plants, fungi, and bacteria in order to survive at temperatures below the freezing point of water. The antifreeze proteins may bind to forming ice crystals and reduce the crystallization of these ice crystals that would otherwise form. Without being bound by a theory, it is believed that including one or more antifreeze proteins in the composition reduces the freezing point of a liquid, like water, that can be combined with the composition and results in the ice pack apparatuses achieving and maintaining a colder temperature.

In one or more embodiments, the composition may include from about 1 wt. % to about 15 wt. % of the antifreeze proteins, based on the total weight of the composition. For example, in some embodiments, the composition may include from about 2 wt. % to about 15 wt. %, from about 5 wt. % to about 15 wt. %, from about 10 wt. % to about 15 wt. %, from about 1 wt. % to about 10 wt. %, from about 1 wt. % to about 7.5 wt. %, from about 1 wt. % to about 5 wt. %, from about 2 wt. % to about 10 wt. %, or from about 3 wt. % to about 8 wt. % of the antifreeze proteins, based on the total weight of the composition.

In one or more embodiments, the antifreeze proteins may include any protein and/or polypeptide that is able to reduce the freezing point of a liquid by reducing the amount of crystallization that occurs when the liquid is introduced to normal freezing temperatures. For example, the antifreeze proteins may be a Type I antifreeze protein, a Type II antifreeze protein, a Type III antifreeze protein, a Type IV antifreeze protein, or a glycoprotein. The antifreeze proteins may have a primary structure of a (alanine-alanine-threonine) disaccharide structure, an alanine-rich alanine-alanine repeated structure, a cysteine-rich disulphide linked structure, or a glutamine, no disulphide bridge structure. The antifreeze proteins may have a secondary structure of an alpha helical amphihilic structure, a beta sheet structure, or an amphipathic alpha helical structure. The antifreeze proteins may have a tertiary structure of a 100% helix structure or a four-helix antiparallel bundle structure. In some embodiments, the antifreeze protein may originate from one or more of, and is not limited to, winter flounder (Pseudopleuronectes americanus), sculpin (Myoxocephalus Scorpius), herring (Clupea harengus), rainbow smelt (Osmerus mordax), Japanese smelt (Hypomesus nipponensis), sea raven (Hemitripterus americanus), longsnout poacher (Brachyopsis rostratus), the Zoarcoidei suborder, rye leaves (Secale cereale), wheat (Triticum aestivum), carrots (Daucus carota), ryegrass (Lolium perenne), potato (Solanum tuberosum), bittersweet (Solanum dulcamara), weeping forsythia (Forsythia suspense), Norway spruce (Picea abis), Blue spruce (Picea pungens), spruce budworm (Choristoneura fumiferana), beetles of the Dendroides, Tenebrio and Rhagium genuses, pale beauty moth (Campaea perlata), midges of the Chironomidae family, Typhula ishikariensis fungus, Lentinula edodes fungus, and/or Flammulina populicola fungus.

The antifreeze proteins may have a molecular mass of from about 1,000 Daltons to about 35,000 Daltons, such as from about 5,000 Daltons to about 35,000 Daltons, from about 10,000 Daltons to about 35,000 Daltons, from about 20,000 Daltons to about 35,000 Daltons, from about 1,000 Daltons to about 25,000 Daltons, from about 1,000 Daltons to about 20,000 Daltons, from about 1,000 Daltons to about 15,000 Daltons, from about 2,000 Daltons to about 20,000 Daltons, or from about 2,000 Daltons to about 10,000 Daltons.

In one or more embodiments, the composition may further include one or more antifreezing agents in addition to the antifreeze proteins that are able to assist in lowering the freezing point of a liquid. For example, in some embodiments, the composition may include one or more of, but is not limited to, methanol, propylene glycol, ethylene glycol, and/or glycerol.

In one or more embodiments, the composition may include sodium chloride. Without being bound by a theory, it is believed that including the sodium chloride in the composition that is contacted with water results in the Na⁺ ions of the dissolved sodium chloride bonding to negatively charged portions of the sodium acrylate polymer and/or additional superabsorbent polymers and Cl⁻ions of the dissolved sodium chloride bonding to positively-charged portions of the sodium acrylate polymer and/or additional superabsorbent polymers so that water molecules can no longer can bond to these areas. Hence, water molecules cannot sufficiently bind together at normal freezing temperatures and lower temperatures are needed in order to have enough bonding between the water molecules in order to form a solid.

In one or more embodiments, the composition may include from about 0.1 wt. % to about 10 wt. % of the sodium chloride, based on the total weight of the composition. For example, in some embodiments, the composition may include from about 0.1 wt. % to about 10 wt. %, from about 1 wt. % to about 10 wt. %, from about 2 wt. % to about 10 wt. %, from about 5 wt. % to about 10 wt. %, from about 0.1 wt. % to about 7.5 wt. %, from about 0.1 wt. % to about 5 wt. %, from about 0.1 wt. % to about 2.5 wt. %, from about 0.5 wt. % to about 7.5 wt. %, or from about 0.5 wt. % to about 5 wt. % of the sodium chloride, based on the total weight of the composition. In one or more embodiments, the composition may include sea salt. The sea salt may consist of at least 80 wt. % sodium chloride. The sea salt may consist of sodium chloride in addition to one or more of, but not limited to, calcium chloride, potassium sulfate, potassium chloride, and magnesium sulfate in addition to one or more ions including, but limited to, sodium, chloride, sulfate, magnesium, calcium, potassium, bicarbonate, bromide, borate, strontium, fluoride, and iodide.

In one or more embodiments, the composition may include one or more ionic salts in addition to the sodium chloride. Without being bound by a theory, it is believed that the ionic salt can assist the sodium chloride in reducing the freezing point of a liquid by having the positive ions from the dissolved ionic salt also bond to various negatively-charged portions of the sodium acrylate polymer and/or additional superabsorbent polymers and having the negative ions from the dissolved ionic salt also bond to various positively-charged portions of the sodium acrylate polymer and/or additional superabsorbent polymers so that water molecules cannot bind to these portions. Hence, water molecules cannot sufficiently bind together at normal freezing temperatures and lower temperatures are needed in order to have enough bonding between the water molecules in order to form a solid. For example, in some embodiments, the ionic salts may be one or more of, but are not limited to, ammonium fluoride, magnesium carbonate, iron (III) hydrogen phosphate, sodium hydroxide, sodium carbonate, sodium bicarbonate, calcium hypochlorite, potassium nitrate, boron trifluoride, copper sulfate, or calcium acetate.

In one or more embodiments, the composition may include magnesium glycinate. Without being bound by a theory, it is believed that including the magnesium glycinate in the composition that is contacted with water results in the Mg²⁺ ions of the dissolved magnesium glycinate bonding to negatively-charged portions of the sodium acrylate polymer and/or additional superabsorbent polymers and the C₂H₄NOO⁻ components of the dissolved magnesium glycinate bonding to positively-charged portions of the sodium acrylate polymer and/or additional superabsorbent polymers so that water molecules can no longer can bond to these areas. Hence, water molecules cannot sufficiently bind together at normal freezing temperatures and lower temperatures are needed in order to have enough bonding between the water molecules in order to form a solid. In one or more embodiments, the composition may include from about 0.1 wt. % to about 10 wt. %, from about 1 wt. % to about 10 wt. %, from about 2 wt. % to about 10 wt. %, from about 5 wt. % to about 10 wt. %, from about 0.1 wt. % to about 7.5 wt. %, from about 0.1 wt. % to about 5 wt. %, from about 0.1 wt. % to about 2.5 wt. %, from about 0.5 wt. % to about 7.5 wt. %, or from about 0.5 wt. % to about 5 wt. % of the magnesium glycinate, based on the total weight of the composition.

In one or more embodiments, the composition may include one or more electrolytes. Without being bound by a theory, it is believed that the ions of the one or more electrolytes will assist the other components in the composition in reducing the contact between liquid molecules and assisting in preventing the formation of a solid. For example, in some embodiments, the one or more electrolytes may be, but are not limited to, lithium triflate (LiCF₃SO₃), lithium bis((trifluoromethyl)sulfonyl)amide (LiTFSI), sodium perchlorate (NaClO₄), or 1-ethyl-3-methylimidazolium tetrafluoroborate.

In one or more embodiments, the composition may include from about 75 wt. % to about 95 wt. % of the sodium acrylate polymer, from about 2 wt. % to about 10 wt. % of the antifreeze proteins, from about 0.5 wt. % to about 5 wt. % of the sodium chloride, and from about 0.5 wt. % to about 5 wt. % of the magnesium glycinate, based on the total weight of the composition. In one embodiment, the composition may include 90 wt. % of the sodium acrylate polymer, 6 wt. % of the antifreeze proteins, 1 wt. % of the sodium chloride, 1 wt. % of the magnesium glycinate, and 2 wt. % of the sea salt, based on the total weight of the composition.

In some embodiments, the composition may include a colored ink or dye component that is able to change the color of at least a portion of the composition. For example, in some embodiments, the composition may include a thermochromic ink or dye that is able to change the color of the composition when a certain temperature range is met. In another example, the composition may include one or more substances that allow the composition to glow or produce photons of light. In another example, the composition may include an ink or dye that is able to allow the composition to produce one or more aesthetically pleasing colors in various hues and patterns. In one or more embodiments, the composition may include one or more substances that allow the composition to emanate a scent, such as scented dyes, scented liquids, scented powders, etc. In some embodiments, the composition may include one or more reacting agents that may facilitate additional bonding between the one or more polymers of the composition. In some embodiments, the contents of the composition may start as individual components and may be combined in whatever order in order to form the composition as described herein.

The present disclosure is also directed to ice pack apparatuses that may hold the composition as described throughout this application. According to one or more embodiments, the ice pack apparatuses may have a body that includes one or more walls, where the one or more walls define a cavity and the composition are included in the cavity of the ice pack apparatuses. The figures depicted and described herein are illustrative examples of ice pack apparatuses that may hold the composition described herein. However, it should be understood that the example ice pack apparatuses are not limiting, and other apparatuses are also contemplated and included within the scope of the present disclosure.

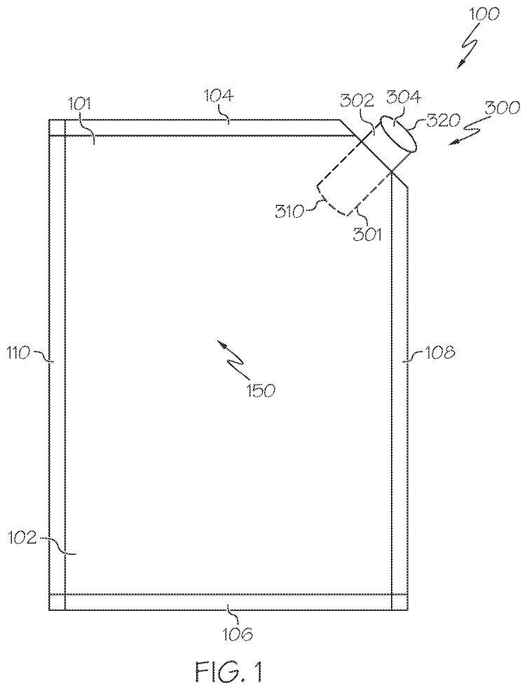

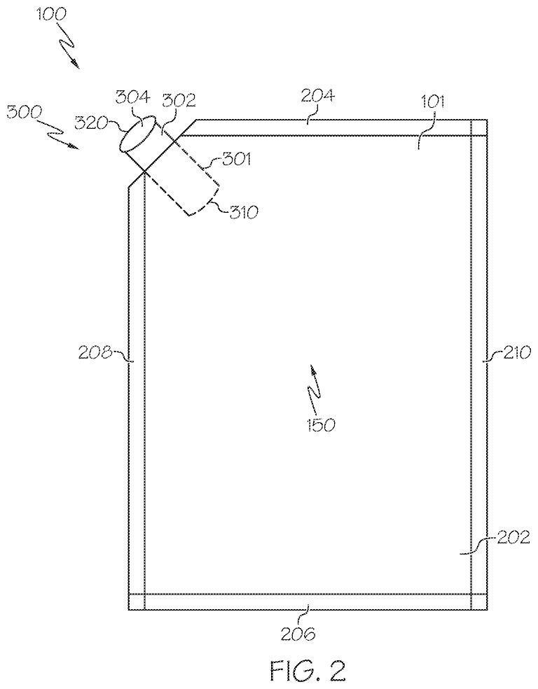

FIGS. 1 and 2 depict a front view and a back view, respectively, of an illustrative ice pack apparatus 100, according to one or more embodiments described herein. The ice pack apparatus 100 may include a body 101 and a front wall 102 that defines a cavity 150 therein for holding a substance, such as, for example, the composition disclosed herein. For example, as shown in FIG. 1, the body 101 of the ice pack apparatus 100 may include a front wall 102 having one or more sides, such as, for example, an upper side 104, a lower side 106, a first side 108, and a second side 110.

Referring to FIG. 2, in another example, the body 101 of the ice pack apparatus 100 may include a back wall 202 that has an upper side 204, a lower side 206, a first side 208, and/or a second side 210. Referring to FIGS. 1 and 2, at least a portion of the upper side 104 of the front wall 102 and at least a portion of the upper side 204 of the back wall 202 may be joined together, at least a portion of the lower side 106 of the front wall 102 and at least a portion of the lower side 206 of the back wall 202 may be joined together, at least a portion of the first side 108 of the front wall 102 and at least a portion of the first side 208 of the back wall 202 may be joined together, and at least a portion of the second side 110 of the front wall 102 and at least a portion of the second side 210 of the back wall 202 may be joined together to form a cavity 150. In one or more embodiments, the cavity 150 of the ice pack apparatus 100 may receive, hold, and/or dispense one or more components. In one or more embodiments, the cavity 150 of the ice pack apparatus 100 may hold the composition as described throughout this application in addition to one or more other components. In some embodiments, the one or more other components may be a liquid including, but not limited to, water.

Still referring to FIGS. 1 and 2, at least one of either the front wall 102 or the back wall 202 of the body 101 of the ice pack apparatus 100 may comprise aluminum and/or nylon. Without being bound by a theory, it is believed that aluminum results in better conductivity of the cooling temperature of the ice pack apparatus 100 to an object when compared to conventional materials due in part to the low resistance of aluminum. Further, without being bound by a theory, it is believed that in embodiments where at least one of either the front wall 102 or the back wall 202 comprise nylon, the additional support provided to at least one of the front wall 102 or the back wall 202 decreases the chance of rupture and/or leaking the contents of the ice pack apparatus 100 when compared to conventional materials, due in part to nylon's strength and tensile properties. In some embodiments, at least one of either the front wall 102 or the back wall 202 of the body 101 of the ice pack apparatus 100 may include one or more additional metal components capable of providing conductive properties to the body 101 from the composition within the cavity 150. In some embodiments, at least one of the one or more walls of the body 101 of the ice pack apparatus 100 may include one or more additional synthetic polymer components capable of providing additional support to the walls of the body 101.

According to one or more embodiments, the ice pack apparatus 100 may further include a nozzle 300 extending through the body 101, such as, for example, through at least one of either the front wall 102 or the back wall 202 of the body 101. The nozzle 300 may be fluidly coupled to the cavity 150 such that a substance within the cavity 150 can be removed through the nozzle 300 and/or a substance can be placed within the cavity 150 via the nozzle 300. Still referring to FIG. 1 and FIG. 2, the nozzle 300 may include a nozzle body 301 having a tubular portion 302 with a first end 310 positioned in the cavity 150 of the body 101 of the ice pack apparatus 100 and a second end 320 opposite the first end 310 and positioned outside of the cavity 150 of the ice pack apparatus 100. In some embodiments, the tubular portion 302 of the nozzle 300 may be cylindrical in shape, but it is noted that other shapes and configurations are possible. The tubular portion 302 of the nozzle 300 may be hollow so that a substance may pass through the nozzle 300. In some embodiments, the nozzle 300 may include various components for inserting a substance, removing a substance, maintaining a substance within the body 101 of the ice pack apparatus 100, and/or the like. For example, the nozzle 300 may include a valve, such as a one-way valve, that allows a substance, such as a fluid, a gel, or the like to flow from the second end 320 to the first end 310 and into the cavity 150, but prevents the fluid from flowing out of the cavity 150. In another example, the nozzle 300 may also include a removable cap 304. In some embodiments, the removable cap 304 may interface with the body 301 of the nozzle 300 such that the removable cap 304 is retained on or in the nozzle 300. For example, an exterior surface of the body 301 of the nozzle 300 may have one or more threads disposed thereon that engage with one or more threads disposed on an interior surface of the removable cap 304 such that the removable cap 304 can be twisted on and off. In another example, the removable cap 304 may function as a plug that is shaped and sized to be press fit over the body 301 of the nozzle 300 or within the body 301 of the nozzle 300. Other configurations of the interface with the body 301 an the nozzle 300 are contemplated and within the scope of this disclosure.

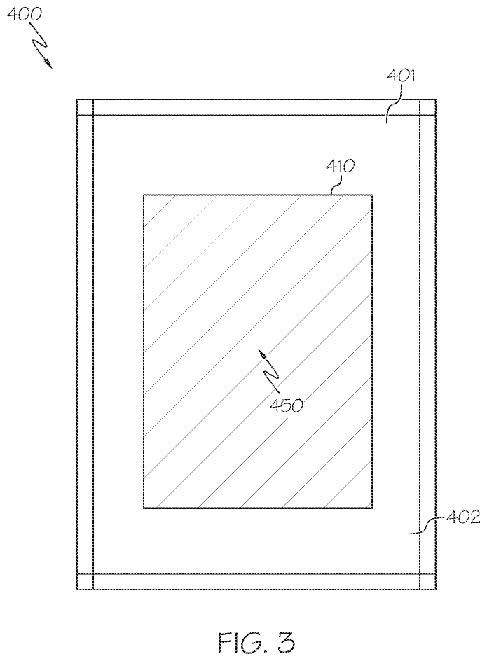

According to one or more embodiments, an ice pack apparatus may have at least one light transmission section. For example, FIG. 3 depicts a front view of an illustrative ice pack apparatus 400 including a body 401 having at least one light transmission section 410. For example, as shown in FIG. 3, the body 401 may include at least one wall 402 constructed of or coupled to a material that defines the light transmission section 410. The material that defines the light transmission section 410 may be a material that allows light to pass through. For example, the light transmission section 410 may be transparent, translucent, or the like. In some embodiments, the light transmission section 410 may be constructed of a material such that the contents within the cavity 450 of the ice pack apparatus 400 are at least partially visible from outside the ice pack apparatus 400. In some embodiments, more than one wall 402 of the body 401 may include a light transmission section 410 thereon. In some embodiments, a wall 402 of the ice pack apparatus 400 may include more than one light transmission section 410. The light transmission section 410 may allow one to more easily inspect the status of the contents within the cavity 450 of the ice pack apparatus 400; for example, identifying whether the contents of the ice pack apparatus 400 are sufficiently solid, have melted, or the like. In some embodiments, the light transmission section 410 may be provided for aesthetic purposes, such as, for example, allowing a user to see color changes in the composition located within the ice pack apparatus 400. In some embodiments, the light transmission section 410 may be provided to allow light from within the ice pack apparatus 400 to emanate outside the ice pack apparatus 400, particularly in embodiments where the ice pack apparatus 400 includes compositions that allow for light emissions, as described herein. The shape, size, and configuration of the light transmission section 410 is otherwise not limited by the present disclosure. That is, in one example, the light transmission section 410 may be a particularly shaped and sized window or the like where only a portion of the walls 402 of the body 401 include the light transmission section 410. In another example, the walls 402 of the body 401 may be constructed of light transmissivity materials so that at least a majority of the body 401 is transparent, translucent, or the like.

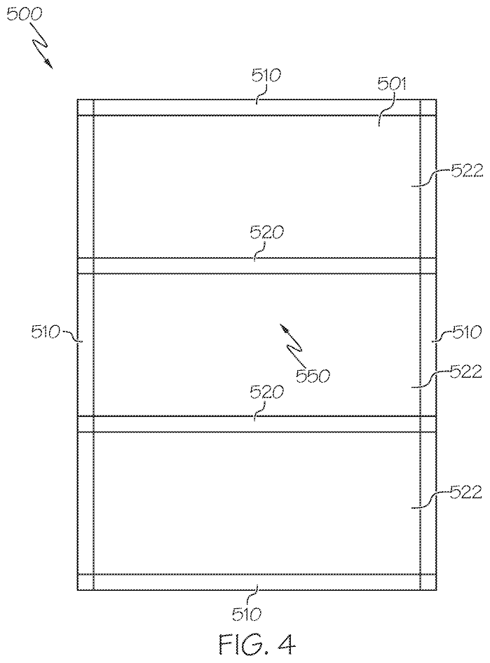

According to one or more embodiments, the cavity of the body of an ice pack apparatus may be divided into a plurality of sections. For example, as shown in FIG. 4, an ice pack apparatus 500 may be divided into a plurality of sections 522, according to one or more embodiments shown and described herein. The body 501 of the ice pack apparatus 500 may further include one or more interior walls 520 within the cavity 550 that define each of the plurality of sections 522. The interior walls 520 may generally extend between one or more exterior walls 510 to form the sections 522. The body 501 of the ice pack apparatus 500 may include at least one interior wall 520 and may include as many interior walls 520 as necessary that may connect in order to form the desired number of sections 522. One or more of the interior walls 520 may not fully extend between one or more of the exterior walls 510 but rather only extend a partial distance between one or more of the exterior walls 510. It is to be understood that the presence of the one or more interior walls 520 within the cavity 550 of the ice pack apparatus 500 may form one or more sections 522 with varying size and shape, where any size and shape sections 522 are contemplated and can be used. One or more of the sections 522 may have the same size and/or shape as another section 522. One or more of the sections 522 may have a different size and/or shape as another section 522. In some embodiments, the one or more interior walls 520 may be positioned within the cavity 550 of the ice pack apparatus 500 to form sections 522 that form polygonal shapes, such as, but not limited to, a circle, square, rectangle, triangle, hexagon, etc. In some embodiments, the sections 522 may be evenly spaced, or near evenly spaced, so that the body 501 of the ice pack apparatus 500 is divided into equal, or near equal, subsections. In some embodiments, the sections 522 may not be evenly spaced, so that at least a portion of the one or more sections 522 do not conform to the size and/or shape of another section 522.

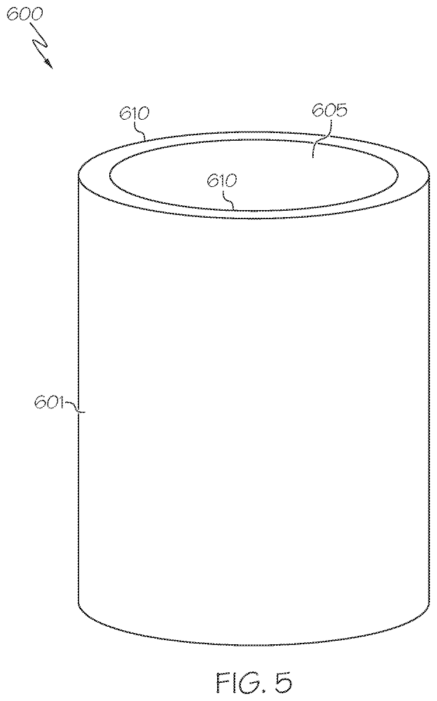

According to one or more embodiments, the body of the ice pack apparatus may form a cylindrical structure having a hollow center portion. For example, as shown in FIG. 5, an ice pack apparatus 600 may have a body 601 that forms a cylindrical structure having a hollow center portion 605, according to one or more embodiments shown and described herein. One or more walls 610 of the ice pack apparatus 600 may each respectively form a cylindrical shape, or near cylindrical shape, and the one or more walls 610 may be joined together so that the formed body 601 of the ice pack apparatus 600 forms a cylindrical structure having a hollow center portion 605. It is believed that this cylindrical structure can allow the ice pack apparatus 600 to wrap around and remain on an object; for example, the ice pack apparatus 600 may fit around an appendage of a human or animal and provide a cooling temperature, the ice pack apparatus 600 may fit around any sized and shaped object and provide a cooling temperature, etc. It is noted that the one or more walls 610 do not have to form a perfect cylindrical shape and many other shapes and configurations of the one or more walls 610 are possible. The one or more walls 610 of the ice pack apparatus 600 may be of any shape and/or size where the connection of these one or more walls 610 forms a three-dimensional shape having a hollow center portion 605. The hollow center portion 605 of the ice pack apparatus 600 may be of any shape and/or size. In some embodiments, the ice pack apparatus 600 may not have a hollow center portion 605, where the one or more walls 610 connect so that the body 601 forms a closed three-decisional shape of varying size and/or shape.

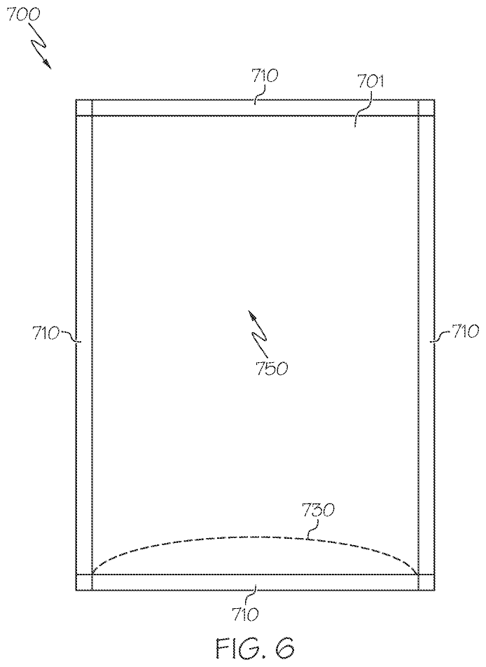

According to one or more embodiments, the ice pack apparatus may further include at least one internal capsule disposed within the cavity of the body. For example, as shown in FIG. 6, an internal capsule 730 may be disposed within the body 701 of an ice pack apparatus 700, according to one or more embodiments shown and described herein. The one or more internal capsules 730 may be disposed anywhere within the cavity 750 of the ice pack apparatus 700. For example, the one or more internal capsules 730 may connect to one or more exterior walls 710 of the body 701 of the ice pack apparatus 700. In some embodiments, the one or more internal capsules 730 may not be connected to any of the exterior walls 710 so that the one or more internal capsules 730 may move around the cavity 750 of the ice pack apparatus 700. In some embodiments, the ice pack apparatus 700 may contain one internal capsule 730. In other embodiments, the ice pack apparatus 700 may contain two or more internal capsules 730. The one or more internal capsules 730 may contain at least one or more components of the composition as described in this application. The one or more internal capsules 730 may contain one or more liquids that may combine with other components located in the cavity 750 or other internal capsules 730 of the ice pack apparatus 700. The one or more internal capsules 730 may contain other components including, but not limited to, various colored dyes, scents, reacting agents, ionic salts, polymer materials, etc. Without being bound by a theory, it is believed that the one or more internal capsules 730 may be configured to burst when a sufficient force is directed onto the internal capsule 730, such as physically squeezing the internal capsule 730, which results in the contents of the internal capsule 730 being mixed with the rest of the contents of the cavity 750 of the ice pack apparatus 700.

As described above, this application is directed to ice pack apparatuses and compositions. These compositions may include a sodium acrylate polymer that may absorb one or more liquids in order to form a hydrogel. The inclusion of one or more of antifreeze proteins, sodium chloride, magnesium glycinate, and sea salt in the compositions may result in lowering the freezing point of the compositions and allowing the compositions to cool an object for a longer period of time. Further, the compositions as described throughout this application may be placed in ice pack apparatuses. These ice pack apparatuses may include a body that contains a cavity that is able to hold the compositions as described herein. In addition, the ice pack apparatuses may be able to introduce one or more liquids into the cavity of the ice pack apparatuses and/or hold the compositions and the one or more liquids in the cavity of the ice pack apparatuses.

The present disclosure includes one or more non-limiting aspects. A first aspect includes a composition comprising a sodium acrylate polymer, antifreeze proteins, sodium chloride, and magnesium glycinate.

A second aspect includes any above aspect, further comprising sea salt.

A third aspect includes any above aspect, wherein the composition comprises from 50 wt. % to 99 wt. % of the sodium acrylate polymer.

A fourth aspect includes any above aspect, wherein the composition comprises from 75 wt. % to 95 wt. % of the sodium acrylate polymer.

A fifth aspect includes any above aspect, wherein the composition comprises from 1 wt. % to 15 wt. % of the antifreeze proteins.

A sixth aspect includes any above aspect, wherein the composition comprises from 1 wt. % to 15 wt. % of the antifreeze proteins.

A seventh aspect includes any above aspect, wherein the composition comprises from 0.1 wt. % to 10 wt. % of the magnesium glycinate.

An eighth aspect includes any above aspect, wherein the composition comprises from 0.5 wt. % to 5 wt. % of the magnesium glycinate.

A ninth aspect includes any above aspect, wherein the composition comprises from 0.1 wt. % to 10 wt. % of the sodium chloride.

A tenth aspect includes any above aspect, wherein the composition comprises from 0.5 wt. % to 5 wt. % of the sodium chloride.

An eleventh aspect includes any above aspect, wherein from 75 wt. % to 95 wt. % of the sodium acrylate polymer; from 2 wt. % to 10 wt. % of the antifreeze proteins; from 0.5 wt. % to 5 wt. % of the sodium chloride; and from 0.5 wt. % to 5 wt. % of the magnesium glycinate.

A twelfth aspect includes any above aspect, wherein the antifreeze proteins comprise one or more of a Type I antifreeze protein, a Type II antifreeze protein, a Type III antifreeze protein, a Type IV antifreeze protein, or a glycoprotein.

A thirteenth aspect includes a body comprising one or more walls, the one or more walls defining a cavity, wherein the cavity holds a composition comprising: a sodium acrylate polymer, antifreeze proteins, sodium chloride, and magnesium glycinate.

A fourteenth aspect includes any above aspect, wherein the one or more walls comprise a front wall and a back wall, wherein the front wall comprises an upper side, a lower side, a first side, and a second side and the back wall comprises an upper side, a lower side, a first side, and a second side; and at least a portion of the upper side of the front wall and at least a portion of the upper side of the back wall are joined together, at least a portion of the lower side of the front wall and at least a portion of the lower side of the back wall are joined together, at least a portion of the first side of the front wall and at least a portion of the first side of the back wall are joined together, and at least a portion of the second side of the front wall and at least a portion of the second side of the back wall are joined together to form the cavity.

A fifteenth aspect includes any above aspect, further comprising a nozzle extending through at least one of the one or more walls of the body, the nozzle fluidly coupled to the cavity.

A sixteenth aspect includes any above aspect, wherein at least one of the one or more walls of the body has at least one light transmission section.

A seventeenth aspect includes any above aspect, wherein the cavity is divided into a plurality of sections.

An eighteenth aspect includes any above aspect, further comprising at least one internal capsule disposed within the cavity of the body, the at least one internal capsule holding one or more components of the composition.

A nineteenth aspect includes any above aspect, wherein the body forms a cylindrical structure having a hollow center portion.

A twentieth aspect includes any above aspect, wherein at least one of the one or more walls of the body comprises aluminum and nylon.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component comprises at least 10%, at least 20%, at least 30%, at least 40%, at least 50%, at least 60%, at least 70%, at least 80%, at least 90%, at least 95%, or even at least 99% that second component (where percentages are disclosed in weight percent unless otherwise noted).

It is also noted that recitations herein of “at least one” component, element, etc., should not be used to create an inference that the alternative use of the articles “a” or “an” should be limited to a single component, element, etc.

For the purposes of describing and defining the present inventive technology it is noted that the terms “substantially” and “about” are utilized herein to represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

What is claimed is:

1. A composition, comprising:
a sodium acrylate polymer;
antifreeze proteins;
sodium chloride; and
magnesium glycinate.

2. The composition of claim 1, further comprising sea salt.

3. The composition of claim 1, wherein the composition comprises from 50 wt. % to 99 wt. % of the sodium acrylate polymer.

4. The composition of claim 1, wherein the composition comprises from 75 wt. % to 95 wt. % of the sodium acrylate polymer.

5. The composition of claim 1, wherein the composition comprises from 1 wt. % to 15 wt. % of the antifreeze proteins.

6. The composition of claim 1, wherein the composition comprises from 2 wt. % to 10 wt. % of the antifreeze proteins.

7. The composition of claim 1, wherein the composition comprises from 0.1 wt. % to 10 wt. % of the magnesium glycinate.

8. The composition of claim 1, wherein the composition comprises from 0.5 wt. % to 5 wt. % of the magnesium glycinate.

9. The composition of claim 1, wherein the composition comprises from 0.1 wt. % to 10 wt. % of the sodium chloride.

10. The composition of claim 1, wherein the composition comprises from 0.5 wt. % to 5 wt. % of the sodium chloride.

11. The composition of claim 1, wherein the composition comprises:
from 75 wt. % to 95 wt. % of the sodium acrylate polymer;
from 2 wt. % to 10 wt. % of the antifreeze proteins;
from 0.5 wt. % to 5 wt. % of the sodium chloride; and
from 0.5 wt. % to 5 wt. % of the magnesium glycinate.

12. The composition of claim 1, wherein the antifreeze proteins comprise one or more of a Type I antifreeze protein, a Type II antifreeze protein, a Type III antifreeze protein, a Type IV antifreeze protein, or a glycoprotein.

13. An ice pack apparatus, comprising:
a body comprising one or more walls, the one or more walls defining a cavity,
wherein the cavity holds a composition comprising:
a sodium acrylate polymer;
antifreeze proteins;
sodium chloride; and
magnesium glycinate.

14. The apparatus of claim 13, wherein:
the one or more walls comprise a front wall and a back wall, wherein the front wall comprises an upper side, a lower side, a first side, and a second side and the back wall comprises an upper side, a lower side, a first side, and a second side; and
at least a portion of the upper side of the front wall and at least a portion of the upper side of the back wall are joined together, at least a portion of the lower side of the front wall and at least a portion of the lower side of the back wall are joined together, at least a portion of the first side of the front wall and at least a portion of the first side of the back wall are joined together, and at least a portion of the second side of the front wall and at least a portion of the second side of the back wall are joined together to form the cavity.

15. The apparatus of claim 13, further comprising a nozzle extending through at least one of the one or more walls of the body, the nozzle fluidly coupled to the cavity.

16. The apparatus of claim 13, wherein at least one of the one or more walls of the body has at least one light transmission section.

17. The apparatus of claim 13, wherein the cavity is divided into a plurality of sections.

18. The apparatus of claim 13, further comprising at least one internal capsule disposed within the cavity of the body, the at least one internal capsule holding one or more components of the composition.

19. The apparatus of claim 13, wherein the body forms a cylindrical structure having a hollow center portion.

20. The apparatus of claim 13, wherein at least one of the one or more walls of the body comprises aluminum and nylon.
